(19) United States
(12) Patent Application Publication
(10) Pub. No.: US 2007/0010187 A1
(43) Pub. Date: Jan. 11, 2007

(54) Ventilator housing

(76) Inventors: Frank Hondmann, Bretten (DE); Jochen Krauter, Hildrizhausen (DE); Helmut Neuschl, Bretten (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 10/539,702

(22) PCT Filed: Dec. 5, 2003
(86) PCT No.: PCT/EP03/13782

§ 371 Date: Aug. 14, 2006

(30) Foreign Application Priority Data
Dec. 19, 2002 (DE) 10259761.8

(51) Int. Cl. B08B 15/00

(52) U.S. Cl. 454/49

(57) ABSTRACT

A ventilator housing for housing at least one ventilator. The ventilator housing includes at least one seat arrangement for the detachable fixing of a plurality of technical components for the operation of the ventilator. The seat arrangement can be integrally formed with the ventilator housing and can include a plurality of fixing elements for securing the technical components in the seat arrangement.

The invention relates to a ventilator housing for housing at least one ventilator.

Ventilator housings are constructed so that they are able to accommodate at least one ventilator. This means that the ventilator housing encloses the ventilator and at the same time forms a channel through which air flows. A ventilator housing is furnished with at least one aperture through which air is sucked in and another aperture through which the air is blown out. Various technical components, such as a mains connection, at least one control board or a condenser are needed in order to operate the ventilator. The technical components are wired together in the known ventilator housings via a plug connector.

One drawback of such conventional ventilator housings is that the technical components are not attached directly to the ventilator housing. Since the technical components are arranged separately from the ventilator housing, additional fixtures are needed to attach them. This entails considerable assembly effort when a ventilator is installed in a ventilator housing, because the technical components must be assembled individually. Moreover, the separate arrangement of the ventilator housing and the additional technical components required to operate the ventilator results in a large space requirement. Additional attachment options for the technical components together with the increased assembly effort are associated with high costs.

The object of the present invention is therefore to create a simple ventilator housing that may be fabricated inexpensively to accommodate at least one ventilator, and on which technical components for operating the ventilator may be arranged directly, thereby minimising the assembly effort and the space required for installing the ventilator housing and the corresponding technical components for operating the ventilator in the ventilator housing.

The invention is inspired by the realisation that this object may be solved in ideal manner by a ventilator housing to which the technical components are attached to the ventilator housing before the ventilator housing is assembled, so as to keep the assembly effort and the installation dimensions as low as possible.

The object is therefore solved according to the invention by a ventilator housing for housing at least one ventilator, in which the ventilator housing is furnished with at least one seat arrangement for the detachable attachment of technical components for operating the ventilator.

The term seat arrangement is understood to mean a retainer in or on the ventilator housing for a technical component for operating the ventilator. In each case, the seat arrangement is designed such that the corresponding component may be easily attached in or on this seat arrangement. Depending on the component to be attached, the size and shape of the seat arrangement may vary. The technical components are particularly control boards, mains connection plugs, condensers or PCB assemblies.

By providing at least one seat arrangement on the ventilator housing, it is possible to simplify the attachment of technical components and the site where the technical components are to be installed is established when the ventilator housing is fabricated. In this way, incorrect assembly may be avoided. In addition, retainers for the technical components that would otherwise have to be provided separately from the ventilator housing may be dispensed with.

The seat arrangement provided according to the invention is preferably constructed integrally with the ventilator housing. In this way, a ventilator housing may be constructed simply and inexpensively on which one or more seat arrangement(s) are already provided for attaching technical components. The integral design of the ventilator housing and the seating device means that no additional fixtures need to be provided, on which the technical components must be arranged when the ventilator housing is assembled. The ventilator housing may be fabricated easily for example in an injection moulding process. The size of the seat arrangement is variable.

The seat arrangement is preferably arranged on the outside of the ventilator housing. This enables particularly simple installation of the technical components on the ventilator housing. The seat arrangements are arranged on the ventilator housing in such manner that they are easily accessible, for purposes of replacing or connecting components, for example. The seat arrangements are usually arranged on the lateral surface and the back of the ventilator housing. The term lateral surface is understood to mean the outer peripheral surface in a housing that has an essentially round profile.

The seat arrangement advantageously includes fixing means, such as grooves, guides, recesses, clip connectors, clamp connections, screwed connectors, plugged connectors and/or similar for attaching the technical components. These fixing means ensure that the technical components are held securely in the seat arrangements of the ventilator housing. Depending on the technical component, these have a corresponding mechanism that is compatible with the seat arrangement. For example, the seat arrangement may include a groove into which the component, particularly a long edge of the component, may be inserted. To ensure secure retention of the component in the groove, clip elements for example may be provided on the seat arrangement and/or on the technical component. Clamping or plugged connectors represent a particularly simple option for securing a component to a seat arrangement. The seat arrangements and the components may also be furnished with holes to allow screwed fixtures.

It is particularly preferred if the technical components are seated in the seat arrangement by positive and/or non-positive locking means. This assures secure retention of the components in or on the seat arrangement. A combination of positive locking and non-positive locking connections assures secure attachment of the components on the seat arrangement. The attachment of the components is designed such that it is easily detachable and the components are removable from the seat arrangement by simple design or technical means.

In a preferred embodiment, at least one of the seat arrangements includes a closure element, particularly a cover, for closing the seat arrangement. In this way, it may be assured that technical components are completely insulated in a seat arrangement and are thus protected from dirt or other external influences. Fixing means to retain the closure element against rotating or twisting may be provided on the seat arrangement. The closure element may also include a plate or similar, which is inserted in or on securing means, particularly grooves, in the seat arrangement. To obtain a secure and tight contact between the closure element and the seat arrangement, in a preferred variant the connection is sealed.

The seat arrangement advantageously has at least one opening for passing cabling or similar through. The opening is advantageously conformed such that the cabling, tube or similar disposed inside the opening is insulated. In a preferred embodiment, the opening is created by the seat arrangement and the closure element, i.e. when the closure element is in the closed position, respective recesses on the seat arrangement and on the closure element form the opening. After a technical component, for example a mains connection plug, has been installed, the power cable is laid in the recess in the seat arrangement and is retained firmly and securely by closing the closure element with a corresponding second recess.

It is further advantageous if the seat arrangement includes at least one mechanism for strain relief of cables or similar. The mechanism for strain relief is preferably arranged on or in the vicinity of the opening for passing cables or similar through, to protect the cable or similar from pulling forces. The mechanism for strain relief may include one or more components. One part of the mechanism may be arranged for example on seat arrangement, and another part of the mechanism may be arranged on the closure element. The two parts cooperate to provide a secure and firm mechanism for strain relief.

A preferred embodiment of the ventilator housing according to the invention provides that at least one condenser, one mains connection, one PCB and/or at least one control board is detachably attached to the seat arrangement. The dimensions of the seat arrangements are such that the technical components described previously may be secured in the seat arrangements by positive locking means.

Wit this design of the ventilator housing it is possible to dispense separate housings for the control board and the mains connector, and a separate retainer for the condenser.

A preferred embodiment of the ventilator housing according to the invention provides that the ventilator housing is furnished with channels, guides and/or retaining means for securing or passing electrical wires through for connecting the technical components with each other. The channels, guides and/or retainers are disposed in such manner that they are able to create a connection between the technical components in the seat arrangements, i.e. electrical wires may be inserted in the channels and/or guides. Secure retention of the wires directly on the ventilator housing may be assured by retainers along the channels and/or guides. The retaining means may be for example clamping elements, clip elements or similar. The channels and/or guides advantageously extend to a point on the outside of the ventilator housing to which a printed circuit board is attached. The use of a printed circuit board enables simple, compact connection or wiring of the components with each other. In addition, fewer plugged contacts are required which in turn reduces the likelihood of errors during assembly.

In a particularly preferred embodiment, the ventilator housing is intended for installation in an extraction hood, particularly in the suction channel or suction duct of the extraction hood. By installing the ventilator housing according to the invention in a extraction hood, a vapour extraction hood may be constructed that occupies very little space and may be assembled very easily. The extraction hood with the ventilator housing according to the invention may also be installed simply, inexpensively, and with very low space requirement.

A ventilator housing may be installed advantageously in an extraction hood, particularly a flat hood, at least one condenser seat arrangement, at least one control board arrangement, at least one mains connection seat arrangement and/or at least one seat arrangement for a PCB being configured integrally with the ventilator housing. Such a ventilator housing represents the ideal solution to the object defined earlier.

In the following, the invention will be described with reference to the accompanying drawing, which shows non-limiting examples of possible embodiments of the invention.

In the drawing:

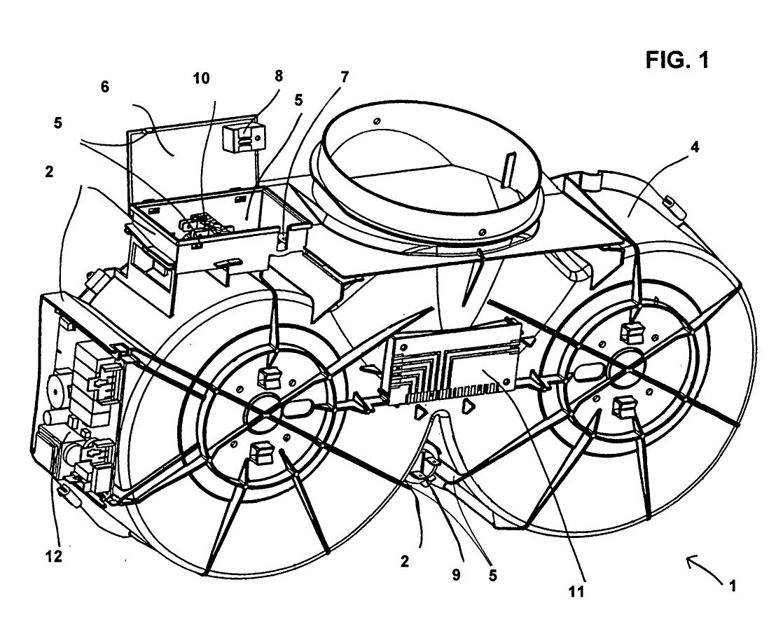

FIG. 1 is a perspective rear view of the ventilator with seat arrangements;

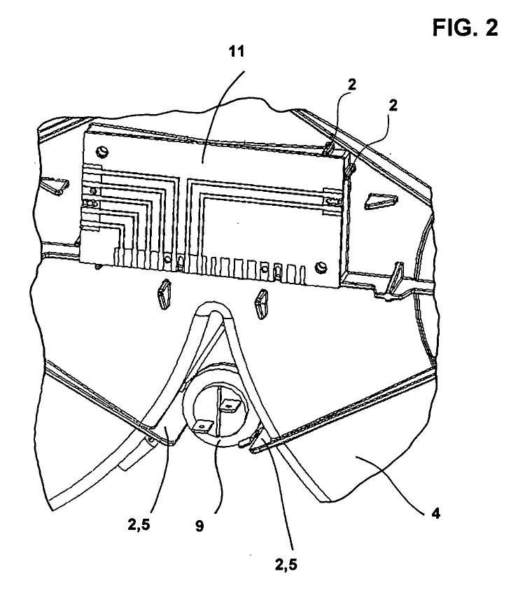

FIG. 2 is a perspective view of a section of the ventilator housing with seat arrangements and a PCB;

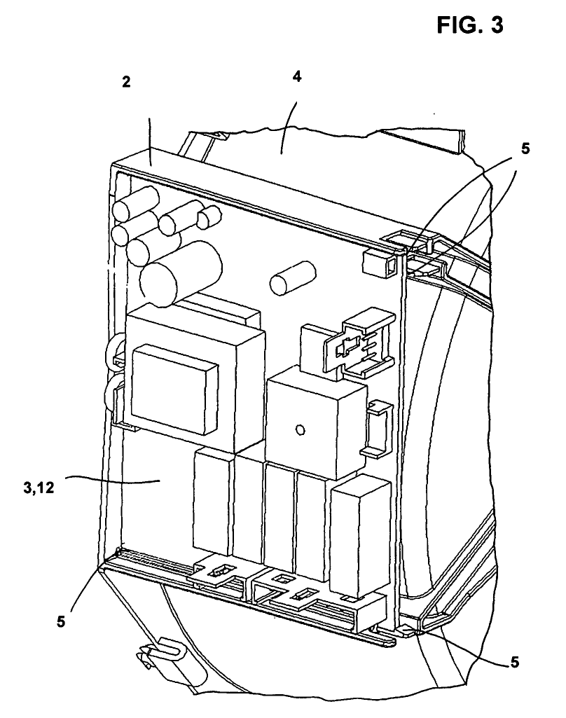

FIG. 3 is a perspective view of a section of the ventilator housing with seat arrangements for a control board;

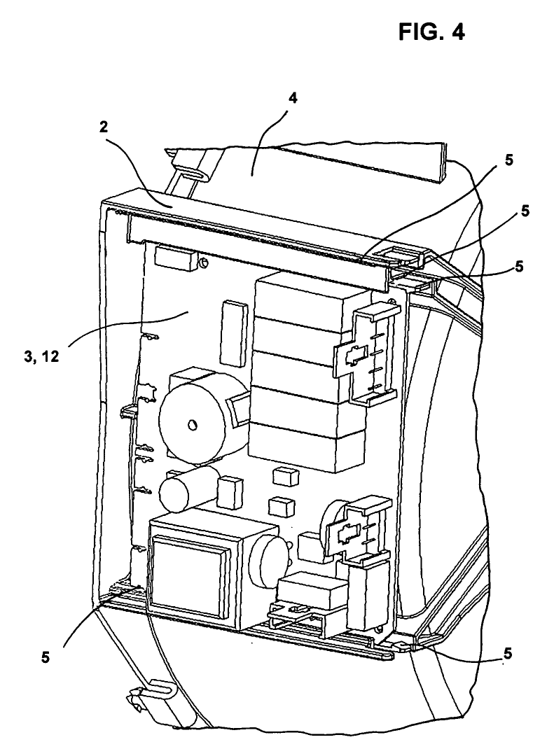

FIG. 4 is a perspective view of a section of the ventilator housing with seat arrangements for a second control board;

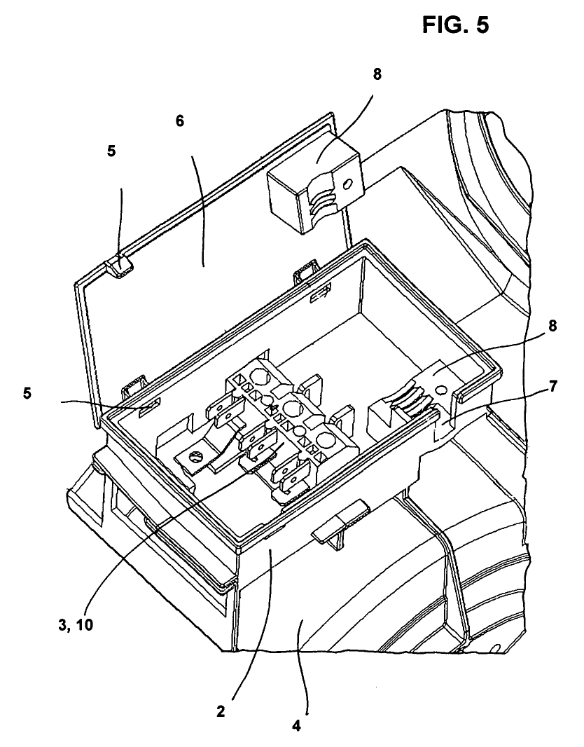

FIG. 5 is a perspective view of a section of the ventilator housing with seat arrangements for a mains connection plug.

FIG. 1 shows an embodiment of a ventilator housing 1 according to the invention with seat arrangements 2 conformed integrally on outside 4 of ventilator housing 1. Seat arrangements 2 are configured variously. Some seat arrangements 2 have the form of studs that accommodate technical components 3, for example a condenser 9 or a PCB 11 by positive and non-positive locking means, and some seat arrangements 2 are recesses or open housings that retain components 3, such as a mains connection 10 or control boards 12, 13 by positive and non-positive locking means.

Seat arrangement 2 for mains connection 10 is constructed as a box and has a closure element 6 in the form of a cover, via which seat arrangement 2 may be closed. Closure element 6 is mounted pivotably on fixing means 5 of seat arrangement 2 for mains connector 10. One mechanism for strain relief 8 is arranged on closure element 6 and one is arranged in seat arrangement 2. When closure element 6 is closed, the two mechanisms for strain relief 8 form a single, effective strain relief mechanism 8, for example for a cable that is passed through opening 7 into the interior of seat arrangement 2 for mains connector 10. When closure element 6 is closed, the cable lies in opening 7 of seat arrangement 2, and is protected from strain and twisting.

Seat arrangement 2 for control board 12 is constructed in the form of a box and is furnished with grooves and clip elements on the side walls of the box as fixing elements 5, which retain control board 12 in seat arrangement 2 by positive and non-positive locking means. Control board 12 is inserted into the grooves and secured with clip elements. Seat arrangement 2 may be furnished with several grooves to that multiple control boards 12 or control boards 12 of different sizes may be inserted.

FIG. 1 also shows a seat arrangement 2 for a condenser 9. This seat arrangement 2 includes a plurality of ribs 5 conformed on the exterior 4 of ventilator housing 1. In this case, exterior 4 itself also serves as a part of seat arrangement 2, since condenser 9 is inserted between a V formed in exterior 4 and two ribs 5, which project into the V-shaped cutaway.

A printed circuit board 11 is arranged on the back of ventilator housing 1. Printed circuit board 11, which represents a relay, is secured to the back of housing 1. The use of a printed circuit board 11 enables simple wiring of technical components 3. For this purpose, printed circuit board 11 is furnished with plugged contacts for the individual technical components.

In the embodiment shown, seat arrangement 2 for the condenser is provided between the two housing sections for two ventilators. In this worm casing, condenser 9 is secured by exterior wall 4 of housing 1 and struts 5 which extend into the gusset area. The printed circuit board is preferably affixed to the rear of the worm casing to allow easy connection with the individual technical components.

In the embodiment shown, the control board is secured in a seat arrangement 2 on the side of ventilator housing 1. Control board 12 may preferably be inserted into seat arrangement 2 from behind, i.e. from the direction of the back wall of ventilator housing 1. In the version shown, seat arrangement 2 for mains connection 10 is provided on the top side of housing 1. This enable easy access to mains connection 10 even after the ventilator housing has been assembled. In the embodiment shown, seat arrangements 2 are conformed directly on the ventilator housing.

FIG. 2 shows a perspective view of a section of ventilator housing 1 with seat arrangements 2. A printed circuit board 11 and a condenser 9 are arranged on ventilator housing 1. Condenser 9 is arranged between extended ribs 5 and exterior 4 of ventilator housing 1. Condenser 9 may be inserted in positive locking manner into the seat arrangement.

In the embodiment shown, the left side of printed circuit board 11 is furnished with plug connectors, via which printed circuit board 11, may be connected to the controller, which may be disposed on board 12. The bottom portion of the printed circuit board is furnished with a plurality of plugs for the two motors that are needed to drive the two ventilators in housing 1. A plug for the condenser is provided on the right side of the printed circuit board. This printed circuit board thus enables easy wiring of the ventilators.

FIGS. 3 and 4 each show a perspective view of sections of ventilator housing 1 with a seat arrangement 2 for a first and another control board 12, 13. Seat arrangement 2 has three lateral walls and is open to the front. A plurality of parallel grooves 5 are provided on the interior circumferential surface thereof, into which control boards 12, 13 are inserted. Control boards 12, 13 are held securely in the grooves via additional fixing means 5, particularly clip elements. The grooves may be of differing dimensions to allow control boards 12, 13 of different sizes to be inserted. This enables easy replacement of control boards 12, 13.

FIG. 5 shows an enlarged perspective view of a section of ventilator housing 1 according to the invention with seat arrangements 2 for a mains connector 10. Mains connector 10 is seated in seat arrangement 2. This means that in this case seat arrangement 2 represents a recess or a housing 5, into which mains connector 10 may be inserted. Seat arrangement 2 includes fixtures 5 for accommodating a closure element 6, particularly a pivotably mounted cover, and an opening 7 through which a cable may be passed. The cable is held firmly and is prevented from twisting in seat arrangement 2 when closure element 6 closes seat arrangement 2. Closure element 6 is itself furnished with fixing means 5, which assure a detachable attachment of closure element 6 to seat arrangement 2.

Ventilator housing 1 according to the invention may be made from plastic or metal. In particular, a plastic housing may be fabricated easily and inexpensively by an injection moulding process.

1-12. (canceled)

13. A ventilator housing for installation in an extraction hood and for accommodating at least one ventilator, comprising:
at least one seat arrangement;
said seat arrangement including a plurality of fixture devices for the detachable fixture of a plurality of technical components for operating the ventilator;
said fixture devices include a plurality of grooves for inserting said components and a plurality of clip elements for securing said components in said grooves.

14. The ventilator housing according to claim 13, including said seat arrangement is constructed integrally with the ventilator housing.

15. The ventilator housing according to claim 13, including said seat arrangement is arranged on the exterior of the ventilator housing.

16. The ventilator housing according to claim 13, including said seat arrangement includes fixing means for securing said technical components.

17. The ventilator housing according to claim 13, including said technical components are secured in said seat arrangement by positive and non-positive locking means.

18. The ventilator housing according to claim 13, including at least one of said seat arrangements include a cover closure element for closing said seat arrangement.

19. The ventilator housing according to claim 13, including at least one of said seat arrangements has at least one opening to allow a cable to pass therethrough.

20. The ventilator housing according to claim 13, including at least one of said seat arrangements has at least one mechanism for strain relief of a cable.

21. The ventilator housing according to claim 13, including at least one of a condenser, a mains connector, a printed circuit board or at least one control board detachably secured to said seat arrangement.

22. The ventilator housing according to claim 13, including the ventilator housing is furnished with a plurality of at least one of channels, guides or retainers for securing or passing through electrical wires for connecting said technical components to each other.

23. The ventilator housing according to claim 13, including the ventilator housing is provided for installation in an extraction hood, particularly in the suction channel or suction duct of said extraction hood.

24. A ventilator housing for installation in an extraction hood, particularly in a flat extraction hood, comprising:
at least one of at least one condenser seat arrangement, at least one control board seat arrangement, at least one mains connection seat arrangement or at least one seat arrangement for a printed circuit board is formed integrally with the ventilator housing.
